(19) United States
(12) Patent Application Publication
(10) Pub. No.: US 2014/0219046 A1
(43) Pub. Date: Aug. 7, 2014

(54) MIXING APPARATUS AND METHODS

(71) Applicant: DXNA LLC, St. George, UT (US)

(72) Inventors: Ray Cracauer, St. George, UT (US); Clark Braten, St. George, UT (US); William Bickmore, St. George, UT (US); Doyle Hansen, St. George, UT (US); Ernie Sumison, St. George, UT (US); Frank Spangler, St. George, UT (US)

(21) Appl. No.: 14/134,736

(22) Filed: Dec. 19, 2013

Related U.S. Application Data
(60) Provisional application No. 61/739,611, filed on Dec. 19, 2012.

(51) Int. Cl. B01F 13/08; B01F 15/06

(52) U.S. Cl. CPC B01F 13/08; B01F 15/06; B01F 2015/062
USPC 366/144; 366/273

(57) ABSTRACT

A method and apparatus for the mixing of a solution and reagents for PCR reactions having a closed cartridge reaction well, a magnetically responsive bead within the well having an optically inert coating and a secondary chemically inert coating. A heat source then heats the contents to a target temperature while oscillating magnetic fields move the bead within the well in order to mix the contents and make the contents of the reaction well homogeneous.

### PRIORITY CLAIM

Priority is claimed to copending U.S. Provisional Patent Application Ser. No. 61/739,611, filed Dec. 19, 2012, which is hereby incorporated herein by reference in its entirety.

### BACKGROUND

It is often desirable that reagents in chemical reactions or biochemical reactions to be as homogeneous as possible so as to obtain an efficient and predictable reaction. In the case of Polymerase Chain Reactions (“PCR”), the reagents, enzymes, primers, probes, target templates, etc., in the solution need to be as homogeneous as possible in order to allow for optimization of the efficiency of amplification of the target reaction.

Many reactions also require a uniform temperature throughout the solution in the reaction well for the reaction to be efficient. PCR also requires uniform temperatures at denature, annealing and reverse transcription for efficient amplification of the target DNA segment to occur.

Mixing the solution of reagents prior to starting the reactions, and in the case of PCR amplification, will often satisfy the requirement of homogeneity in an open reaction well system. This mixing is usually done as the reagents are added to the open reaction well.

### BRIEF DESCRIPTION OF THE DRAWINGS

Additional features and advantages of the invention will be apparent from the detailed description which follows, taken in conjunction with the accompanying drawings, which together illustrate, by way of example, features of the invention:

FIG. 1 is a cross-sectional view of a first embodiment of a magnetically responsive mixing bead capable of use within a mixing apparatus in accordance with an embodiment of the present invention;

FIG. 2 is a cross-sectional view of a second embodiment of a magnetically responsive mixing bead capable of use within a mixing apparatus in accordance with an embodiment of the present invention;

FIGS. 3a-3d are side views depicting a closed reaction well in accordance with an embodiment of the present invention containing a magnetically responsive mixing bead; various levels of solutions and reagents are shown in the various figures;

FIGS. 4a-4b are perspective, partially schematic views depicting various positions of a magnet with respect to the reaction well and how a corresponding magnetic field may affect the position of the mixing bead;

FIGS. 5a-5b are perspective, partially schematic views depicting positioning of a plurality of magnets with respect to the reaction well and how this may induce movement of the mixing bead within the reaction well at increased speeds;

FIGS. 6a-6b are perspective, partially schematic views depicting an electromagnet being used to induce movement of the mixing bead within the reaction well;

FIGS. 7a-7b are perspective, partially schematic views depicting a plurality of electromagnets being positioned about the reaction well in order to induce movement of the mixing bead within the reaction well at increased speeds;

FIGS. 8a-8c are perspective, partially schematic views depicting a mechanically displaced electromagnet configured to move the bead in accordance with one aspect of the present invention which utilizes magnets and magnetomotive force to move the electromagnet and thereby vary the magnetic fields within the reaction well;

FIGS. 9a-9b are perspective, partially schematic views depicting a mechanically displaced electromagnet configured to move the bead in accordance with one aspect of the present invention which utilizes a directional switch of the current through the coils of the electromagnet in order to displace the electromagnet and thereby to vary the magnetic fields within the reaction well;

FIG. 10a is a top view depicting a mechanically displaced magnet being placed on a rotating shaft which is configured to rotate the magnet about the reaction well and thereby vary the magnetic fields within the reaction;

FIGS. 10b-10c are top views of the system shown in FIG. 10a;

FIG. 11 is a side, partially schematic view depicting the use of the electromagnet configuration of FIGS. 8a-8c as used in conjunction with an optics head;

FIG. 12 is a side, partially schematic view depicting the use of the rotating shaft configuration of FIGS. 10a-10c as used in conjunction with an optics head;

FIGS. 13a-13c are side, partially schematic views depict an alternative rotating shaft configuration which rotates magnets and their corresponding magnetic fields in and out of range of the reaction well in yet another embodiment of the present invention;

FIGS. 14a-14b are side, partially schematic views depicting the use of the rotating shaft configuration which rotates magnets and their corresponding magnetic fields in and out of range of the reaction well both above and below the reaction well; and

FIG. 15 depicts a flow chart embodying a method for achieving a homogeneous solution and reactants during a heated PCR application.

Reference will now be made to the exemplary embodiments illustrated, and specific language will be used herein to describe the same. It will nevertheless be understood that no limitation of the scope of the invention is thereby intended.

### SUMMARY OF THE INVENTION

It has been recognized that it would be advantageous to develop a mixing apparatus operable with a closed cartridge reaction well that can maintain a homogeneous mixture within the reaction well during a heating process to a target temperature.

The invention provides a variety of methods of oscillating a magnetic field within a PCR reactor having a closed cartridge reaction well that is capable of rapidly displacing a magnetically responsive bead within the well, which can in turn mix the contents and maintain a homogeneous consistency and temperature.

### DETAILED DESCRIPTION OF EXAMPLE EMBODIMENT(S)

### Definitions

As used herein, the singular forms “a” and “the” can include plural referents unless the context clearly dictates otherwise. Thus, for example, reference to “a heating unit” can include one or more of such units.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

Relative directional terms are sometimes used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art. In particular, the term “side” is sometimes used herein to describe a boundary of a vessel or a well. It is to be understood that such term is not limited to a lateral portion of the vessel or well, but can include a top, bottom, lateral portion, etc.

As used herein, the terms “closed” or “sealed” reaction well or container are to be understood to refer to a well or container that is sealed on all sides (e.g., there is no “open” top or side portion). A closed or sealed well or container may be closed or sealed to varying degrees. In one aspect, the well or container is sealed so as to be liquid-tight: that is, liquid cannot enter or exit the well or container during normal operation. In one aspect, a closed or sealed well or container can be closed to the extent that mixing beads contained within the well or container cannot exit the container. In one aspect, the well or container can be gas-tight: that is, no gas can enter or exit the well or container during normal operation.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Invention

It has been recognized that in order for chemical reactions or biochemical reactions to be efficient the solution of reagents must be as homogeneous as possible. In the case of Polymerase Chain Reactions (PCR) the reagents, enzymes, primers, probes, target templates, etc., in solution need to be as homogeneous as possible so that efficient amplification of the target can occur. Many reactions also require a uniform temperature throughout the solution in the reaction well for the reaction to be efficient. PCR also requires uniform temperatures at denature, annealing and reverse transcription for efficient amplification of the target DNA segment to occur.

Mixing the solution of reagents prior to starting the reactions and in the case of PCR amplification, will often satisfy the requirement of homogeneity and in an open system it is usually done as the reagents are added to the reaction well. The mixing step for homogeneity within a closed cartridge system becomes much more difficult. Where uniform temperature is required, either the solution in the reaction well needs to have its temperature tightly controlled, or the solution needs to be mixed so that temperature gradients within the solution are minimized.

The present technology addresses these issues in a variety of manners. In one embodiment, a method of mixing chemical reagents or biochemical reagents (such as PCR reagents in a reaction well or mixing chamber) is provided. The method can be accomplished in a standalone well or chamber or within a closed cartridge (e.g., container) system. The method can include using beads that are made from magnetically responsive materials or alloys and coated with a chemically or biochemically inert coating such as parylene. The method includes various means or manners to move the beads inside the reaction well or mixing chamber, thus causing mixing to occur.

In one aspect of the invention, beads made of magnetically responsive material are coated with a material that is inert to chemical or biochemical reactions. These beads can be used to mix the chemical or biochemical solution to provide homogeneity and reduce the effects of any thermal gradients within the mixing chamber or reaction well.

In another aspect of the invention, various means or methods are carried out to move the beads within the mixing chamber or reaction well. The present technology can cause sufficient mixing to achieve the desired homogeneity and reduction of thermal gradients, thus enhancing the efficiency of the desired reaction.

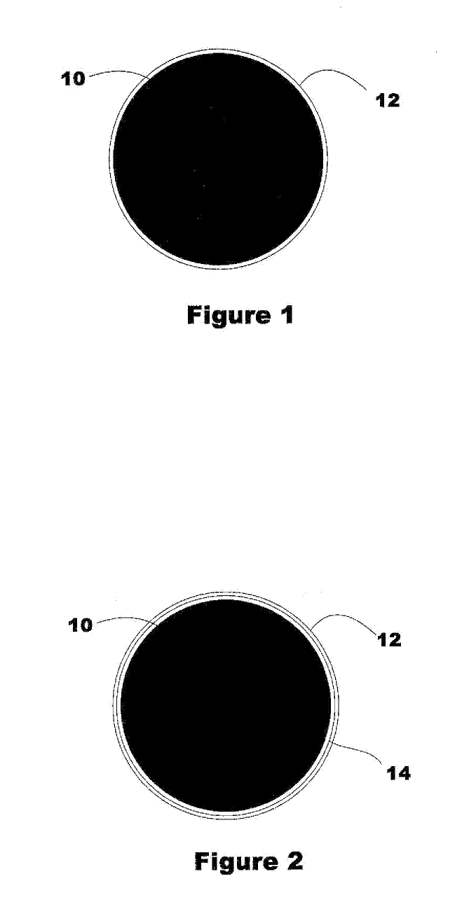

An embodiment of the invention is illustrated generally in FIG. 1. In this aspect, the bead 10 can be made of a magnetically responsive material such as iron, nickel, cobalt or some alloy thereof. While the bead can be magnetized, in many embodiments it is not formed of a magnetic material, nor is it magnetized. The bead 10 can be coated with a thin chemically inert coating 12. The bead 10 can be sized according to the needs of the mixing chamber and the strength of the magnet used to move the bead. In one preferred embodiment the bead 10 is steel shot that is about 1.5 to about 1.65 mm in diameter and the coating 12 is about 5 microns of parylene.

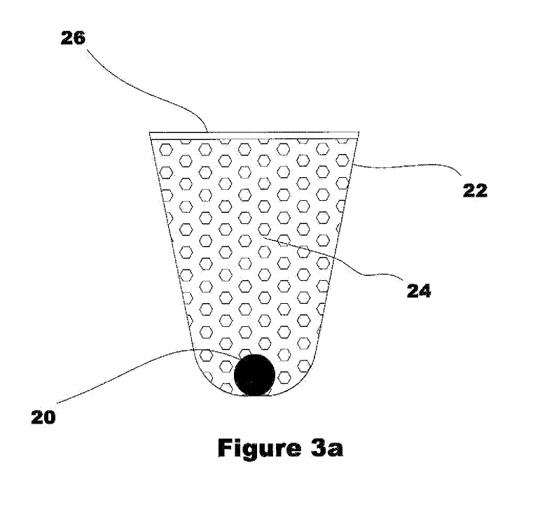

Another embodiment of the invention is shown in FIG. 2. Once again the bead 10 is made of a magnetically responsive material such as iron, nickel, cobalt or some alloy thereof, but it is not a magnet nor has it been magnetized. The bead 10 is coated first with a thin optical coating 14 to counteract any negative optical effect that the natural color of the bead might have on any optical detection system used to read the progress of the chemical or biochemical reaction in the mixing chamber. The thin optical coating 14 can be white, such as titanium dioxide or a mirror type of coating such as nickel. The bead is then coated with a thin coat 12 of a chemically inert material such as parylene. Once again, the bead 10 should be sized according to the needs of the mixing chamber and the strength of the magnet used to move the bead, only in this case the extra layer of coating material is taken into consideration.

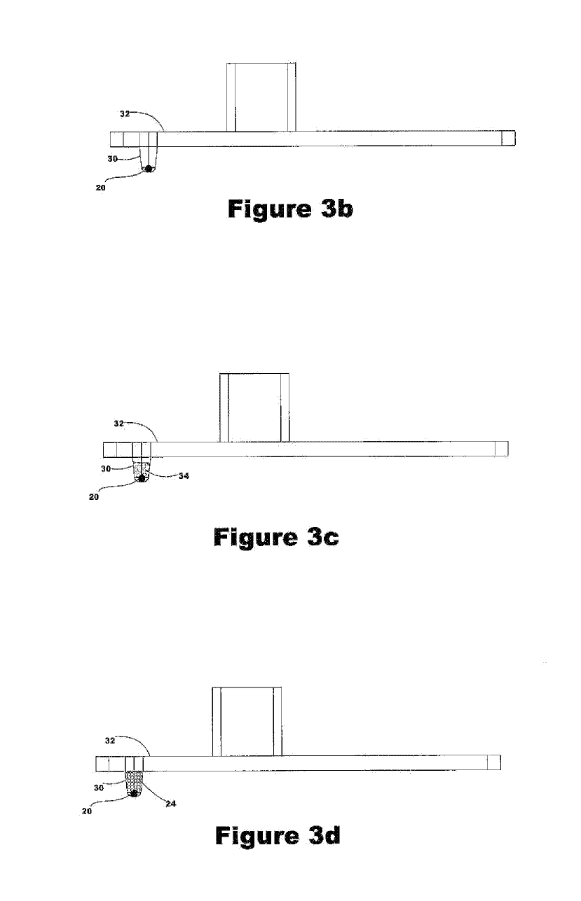

FIG. 3a shows a coated bead 20 as described in FIG. 1 placed inside a closed cartridge reaction well 22 that is also filled with a solution and various reagents 24. In the case of PCR, there can also be templates, probes, primers, etc., present. The well can include a barrier 26 that stops the bead's upward motion. The barrier is typically made of a material that does not shield the bead from magnetic flux. In the case that the progress of the reaction is monitored from above by an optics system, the barrier material and configuration should also accommodate the optics system. The barrier is essentially a lid or covering on a container within the well, or the well itself, that creates a closed vessel in which the various materials are held. The barrier can be formed of a variety of materials and can be attached to the vessel or reaction well in a variety of manners. Typically, the barrier will be removably attached to the vessel or well. Non-limiting examples include a “snap-on” attachment, threaded attachment, hinged attachment, and the like. In some cases, a pressure- and/or heat-sensitive film or material can be applied to create the barrier.

FIGS. 3b through 3d are examples of the coated bead 20 as described in FIG. 1 in the reaction chamber of a closed cartridge test system as the cartridge is being manufactured. FIG. 3b shows the bead 20 in the reaction well 30 of a closed cartridge or vessel 32. FIG. 3c shows the bead 20 included in the well 30 of a closed cartridge system 32 with lyophilized chemical or biochemical reagents, and in the case of PCR, with primers and probes 34. FIG. 3d shows the bead 20 included in the well 30 of a closed cartridge system 32 with a solution of chemical or biochemical reagents, and in the case of PCR, probes, primers, templates, etc.

Generally speaking, to move the bead and cause mixing to occur, a magnetic flux is brought into proximity of the reaction well or the mixing chamber containing the bead. The bead, being made of magnetically responsive material, will be drawn toward the magnetic flux and pass through the solution. The magnetic flux can be brought into the proximity of the well and the magnetically responsive bead by moving a permanent magnet into the appropriate position or energizing an electromagnet that is already in the appropriate position. Depending on the orientation of the mixing chamber or reaction well and the desired speed of mixing, either gravity or another magnetic flux can be used to draw the bead in the opposite direction from which it was first drawn. This back and forth or up and down action of the bead, done repetitively and at a fast enough rate, will cause the components of the solution to mix.

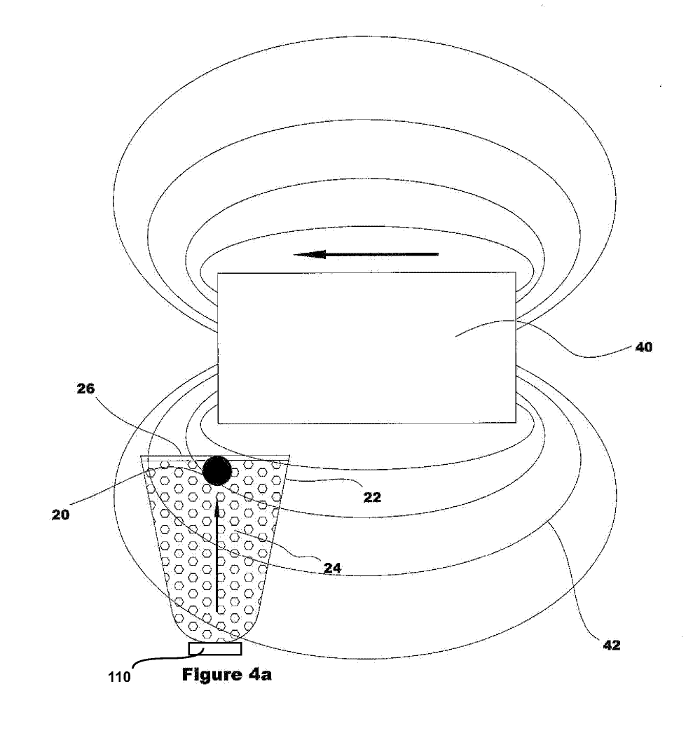

As a non-limiting example, FIGS. 4a-b show a magnet 40, which can be a rare earth magnet. In FIG. 4a, the magnet is being brought into position over a reaction well 22 containing reagents 24. In this manner, the magnetic flux 42 extends downwardly into the well 22 far enough to draw the coated steel bead 20 up to the barrier 26 of the reaction well 22. FIG. 4b shows that the magnet 40 is pulled far enough away from the reaction well 22 such that the magnetic flux 42 will no longer draw the bead 20 toward the magnet 40. At this point, the bead 20 will drop to the bottom of the reaction well 22. When relying on gravity to move the bead 20 to the bottom of the well 22 the magnet 40 must be drawn far enough away from the well 22 and the bead 20 that the magnetic flux 42 of the magnet 40 will not intersect with the temporary magnetic field 28 that is generated by the magnetic responsive bead. Heat can be applied to the closed cartridge reaction well by heat source 110. It should be appreciated that heat source 110 may be any suitable heat source as recognized by one of ordinary skill in the art.

In one specific example, a conventional cartridge heater is used. In this case, nichrome wire heating coils are inserted in holes formed in ceramic tubes. Pure magnesium oxide filler is vibrated into the holes housing the heating coils to allow maximum heat transfer to the stainless steel sheath. The heater then has a heliarc welded end cap inserted on the bottom of the heater and insulated leads are installed. While the heat source is shown near the bottom of the vessel or well, it is to be understood that it can be positioned in a variety of locations: aside, above, circumventing the vessel or well, etc. In addition, while the teachings herein refer to the heat source specifically, it is to be understood that thermal management of the contents of the well or vessel can be carried out using a cooling unit as well. Such a cooling unit can be positioned as discussed with the heating source, as would be appreciated by one of ordinary skill in the art.

As previously stated, the mixing motion of the bead in the configuration demonstrated in FIGS. 4a and 4b relies on gravity to pull the bead to the bottom of the well. This can be a limiting factor when it comes to the speed of the mixing action.

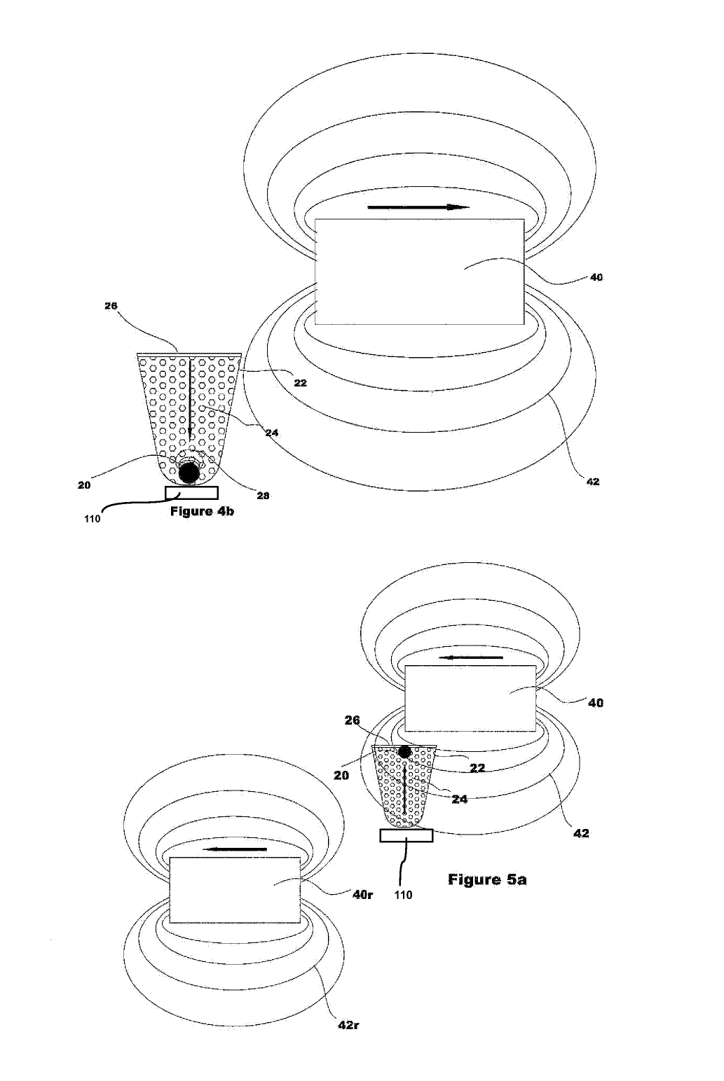

FIGS. 5a and 5b show an example of an embodiment that can greatly enhance the speed of the mixing. The bead 20 will be influenced by two magnetic fields 42 and 42r, each pulling the bead in the opposite direction from the other. In FIG. 5a, as in FIG. 4a, a magnet is brought into position over the reaction well 22 such that the magnetic flux 42 of the magnet 40 will draw the bead 20 to the top of the well 22 against the barrier 26. Next, as seen in FIG. 5b, the magnet 40 is pulled away from the well 22 so that its magnetic flux 42 no longer affects the bead 20. At substantially the same time, a magnet 40r near the base of the well 22 is brought into position under the reaction well 22 such that the magnetic flux 42r of magnet 40r draws the bead 20 towards the bottom of the well 22. This embodiment allows mixing to occur at a pace dependent on the depth of the well 22 and the speed at which the magnets 40,40r can be moved. This dual magnet configuration increases the relative oscillating speed of the bead thus increasing the ability to maintain the homogeneity of the solution while heat is being applied via heat source 110.

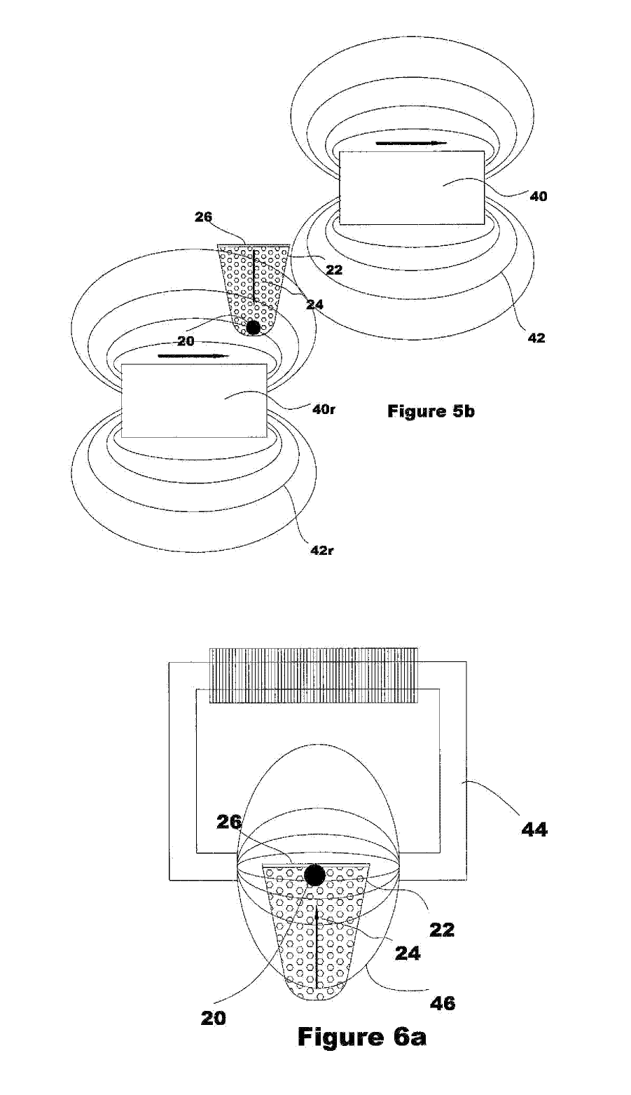

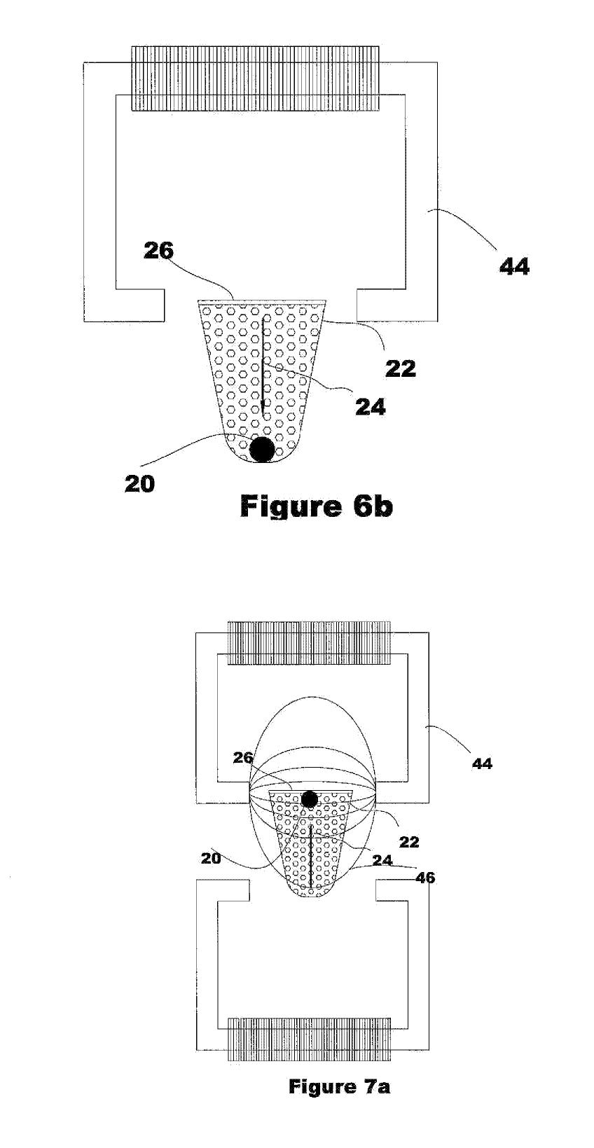

FIGS. 6a and 6b show an embodiment using an electromagnet 44 with a ‘C’ shaped core to bring a magnetic flux 46 into position to draw the bead 20 toward it and, in this embodiment, to the top of the well 22 and against the barrier 26. In FIG. 6a the electromagnet 44 is energized with a DC current adequate to generate enough magnetic flux 46 to reach into the well 22 and draw the bead 20 up through the solution 24. In FIG. 6b the DC current is turned off, causing the magnetic flux 46 to collapse, thus allowing the bead 20 to drop through the solution 24 to the bottom of the well 22. As in the case of using a magnet as described above and in FIGS. 4a and 4b, using gravity to return the bead 20 to its starting position limits the pace at which the bead 20 can be moved and the rate at which mixing can occur. FIGS. 7a and 7b show a configuration analogous to the configuration describe in FIGS. 5a and 5b. In this case a ‘C’ shaped electromagnet is placed both above 44 and below 44r the well 22 and the DC current is switched between the two electromagnets. In FIG. 7a the top electromagnet 44 is energized, its magnetic flux 46 thus drawing the bead 20 up through the reagent solution 24 in the well 22 until it reaches the upper barrier 26. In FIG. 7b the DC current is then switched to the lower magnet 44r and its magnetic flux 46r draws the bead 20 back down through the solution 24 until it hits the bottom of the well 22.

FIGS. 4a, 4b, 5a, 5b, 6a, 6b, 7a and 7b are just examples of possible ways to use the magnetically responsive coated beads. The wells in FIGS. 4a, 4b, 6a, and 6b can be dedicated mixing chambers in or out of a cartridge based system or in a dedicated sample processing system. The wells in FIGS. 5a, 5b, 7a, and 7b can be horizontally configured wells or vertical or horizontal mixing chambers and in or out of a cartridge based system or in a dedicated sample processing system.

The technology also provides various methods suitable to move the magnetic flux into position to cause the bead to move through the solution in the well or mixing chamber, thus causing mixing. The first method was disclosed in the above discussions of FIGS. 6a, 6b, 7a, and 7b which describe how to move the bead through the solution in the well or mixing chamber using an electromagnet with the appropriate core and magnetic flux. The advantages of this method is that it requires no moving parts and a single DC current switched on and off will provide the magnetic flux needed to move the bead. Where space and sufficient power are available, this is an adequate method to move the bead. Other methods of moving the bead will be described below.

For purposes of the following discussion, it will be assumed that moving a magnet also moves the magnetic flux of the magnet, or the magnetic field of the magnet, so that reference to moving a magnet into position to move the beads also refers to moving the magnet's magnetic flux into position to move the beads. This assumption applies to the drawings as well. It will be assumed that magnets in the drawings have a magnetic flux and the magnetic flux will not always be represented in the drawings.

In one aspect of the invention, the magnet is a rare earth magnet, and in particular a neodymium magnet. The size and strength of the magnets used will depend on the available space in which to move the magnet, the size and depth of the well, vessel or mixing chamber, the method used to move the magnet, the orientation of the well, and the orientation of the magnet in relationship to the well.

Generally, the most effective methods of moving the magnet are methods that require very few moving parts with few or no mechanical linkages, that have low voltage and current requirements, and that can be controlled easily with a microcontroller or simple timer circuit. One embodiment disclosed changes the direction of the DC current to move the magnet in and out of position, but simpler embodiments do not require the additional circuitry to accomplish this switching.

All methods disclosed here can be applicable to a vertical, horizontal, or even a diagonal orientation of the reaction well or the mixing chamber. The well or chamber can be either stand alone or in a cartridge based system. The embodiments disclosed herein are not meant to constrain mixing to only one orientation of the reagent well or mixing chamber, or to only stand alone or cartridge based systems, but to include all well/chamber orientations and stand alone or closed systems.

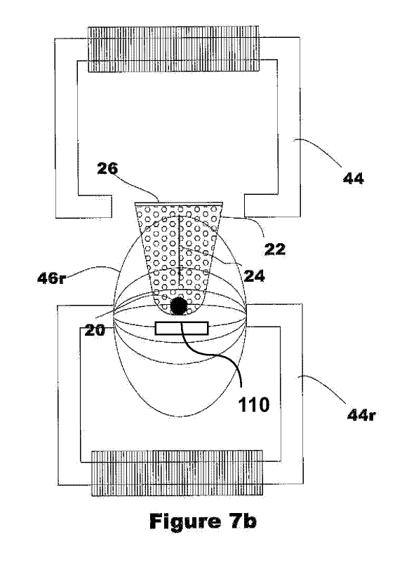

FIGS. 8a, 8b, and 8c illustrate one mechanical system for moving the magnets into and out of position. This method uses the magnet 58 to pull the bead 20 up through the solution 24 and allows gravity pull the bead back down through the solution. The magnet is pushed forward by the magnetomotive force generated by the energized coil 56 and drawn back from the well by de-energizing the coil 56 and using the magnetic flux provided by the small magnets 52a and 52b. A non-magnetically responsive material such as aluminum or plastic is used as a barrier 60 to stop the forward motion of the magnet.

FIG. 8a shows the magnet pushed forward by the magnetomotive force generated by the coil 56. Its forward motion has been stopped by the barrier 60 in such a position that it will lift the bead 20 in the well 22 up through the solution 24. FIG. 8b shows the coil 56 de-energized and the magnet 58 pulled back into the bobbin 50 by the attraction of the magnets 52a and 52b, allowing the bead 20 to drop back down through the solution 24 in the well 22. If more rapid mixing were required, the same mechanism described here, or some other method of putting a magnetic flux at the bottom of the well could be used as disclosed in FIGS. 5a, 5b, 7a, and 7b.

The system described in FIGS. 8a, 8b, and 8c involves designing a plastic bobbin 50 that has two functions. The first is that it be shaped to provide a path for the magnet 58 to travel to and from the position that will allow the bead 20 to be raised and dropped. The second is to hold enough windings of wire so that when the coil 56 is energized with a DC current it will generate enough magnetomotive force to push the magnet forward out of the bobbin. The bobbin also has some relative dimensions and other items that are disclosed in the discussion of FIG. 8c. The method disclosed here uses a single direction DC current that is simply turned on and off with a microcontroller or a simple timing circuit, as would be appreciated by one of ordinary skill in the art. One manner of pulling the magnet 58 back into the bobbin and thus away from the well and the bead is a magnetic flux that is polarized such to attract the magnet 58 and pull it quickly back into the bobbin. The magnetic flux can be provided by one or a plurality of magnets. In the embodiment shown, the magnet flux is provided by two magnets 52a and 52b. The strength, orientation and position of magnets 52a and 52b are important. They must be strong enough to pull the magnet 58 back into the bobbin 50, they must be oriented to attract, rather than repel the magnet 58, and they must be positioned such that their attraction to the magnet 58 can be overcome by the magnetomotive force generated by the energized coil 56.

As stated before, FIG. 8c discloses some relative dimensions and other particulars in the bobbin 50 that allow the back and forth motion to work in this particular embodiment. A vent hole 58 can be positioned at the end of the bobbin 50. This allows air to escape as the magnet 58 is pulled back into the bobbin 50. The center of the coil area 72 must generally be further back on the bobbin then the center of the magnet 70

As a non-limiting example, the materials and approximate dimensions used to assemble the method disclosed in FIGS. 8a, 8b, and 8c are as follows. The plastic bobbin 50 is approximately 1.75 inches long with outside diameters of about 0.6 inches on the large diameters and about 0.5 inches on the small diameters. The internal diameter is about 0.38 inches with a depth of about 1.5 inches. The magnet 58 is a 0.375 inches×1 inch neodymium magnet, and the magnets 52a and 52b are 0.25×0.25 inch neodymium magnets. The coil area 74 (in FIG. 8c) on the bobbin 50 is about 1 inch long. The coil is a winding of 850 turns of #34 magnet wire and is energized by a DC current of 0.5 amps at 12 volts.

The magnets 52a and 52b are encased in a housing that slips over the completed bobbin 50 and holds the magnets 52a and 52b opposite from each other about 0.1875 inches from the side of the coil 56 and about 0.25 inches from the end of the bobbin 50. The barrier 60 is an aluminum block. The “pull up” position of the magnet 58 in FIG. 8a is approximately 0.125 inches past the edge of the well and about 0.125 inches above the well. The switching on and off of the DC current is controlled by a PIC18F1220 microcontroller at up to 5 Hz. This mixing frequency can be easily varied with the firmware, as would be appreciated by one of ordinary skill in the art. The orientation of the magnets 58, 52a and 52b is determined by the direction that the DC current is flowing through the coil 56. Large magnet 58 can be positioned in the bobbin 50 and energize the coil 56. If the magnet 58 is pushed out, then the orientation is correct, if it is pulled in, then either the direction that the DC current is flowing through the coil 56 can be switched, or the magnet 58 can be turned around. Once the large magnet is oriented correctly then it is a simple step to orient the magnets 52a and 52b to hold the large magnet 58 in the bobbin 50.

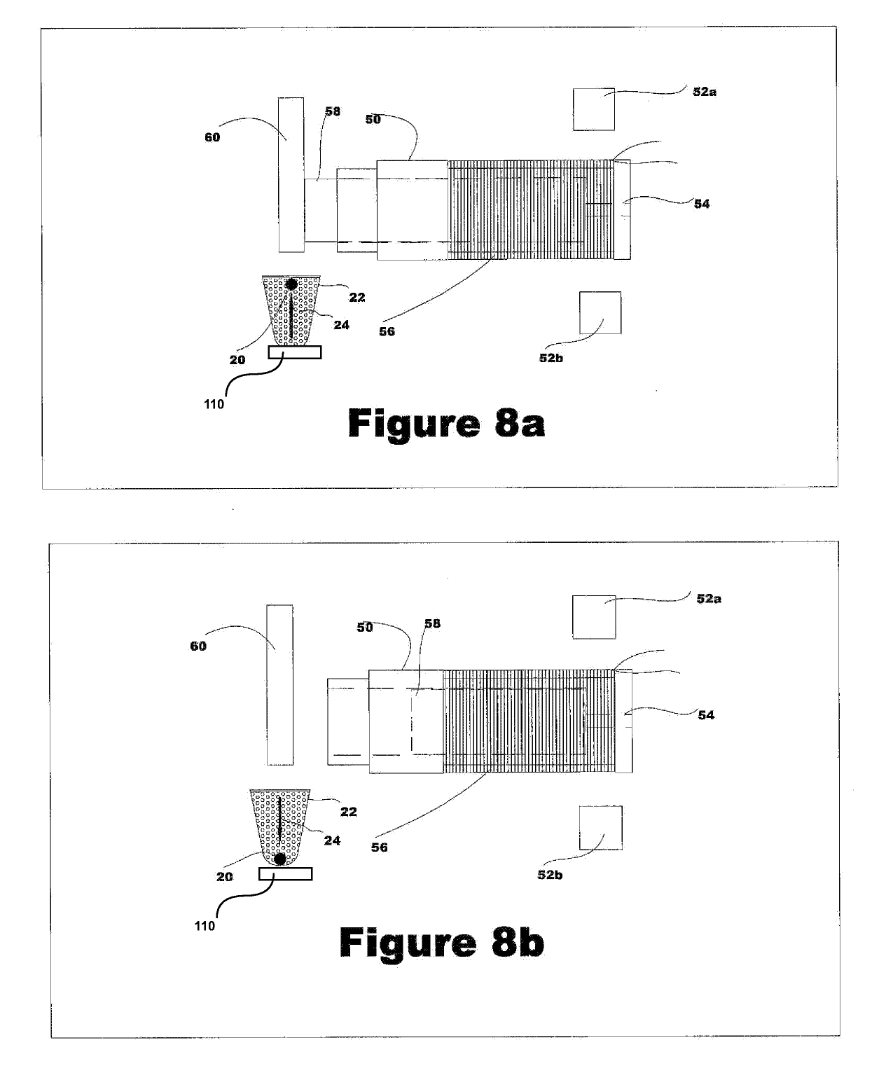

Another method to move the magnet into position to move the bead in a reaction well or mixing chamber is disclosed in FIGS. 9a and 9b. This method is very similar to the method disclosed in the discussion of FIGS. 8a, 8b, and 8c. The primary difference is the removal of the magnets 52a and 52b shown in FIGS. 8a, 8b, and 8c, and instead sending the DC current in one direction of the coil 56 to push the magnet 58 out to the “pull up” position as shown in FIG. 9a. Then the direction of the DC current through the coil 56 can be switched to pull the magnet away from the well 22 and bead 20 allowing the bead 20 to drop back through the solution 24 to the bottom of the well 22. Once again, if more rapid mixing were required, the same mechanism described herein, or some other method of putting a magnetic flux at the bottom of the well could be used (for example, the techniques shown in FIGS. 5a, 5b, 7a, and 7b).

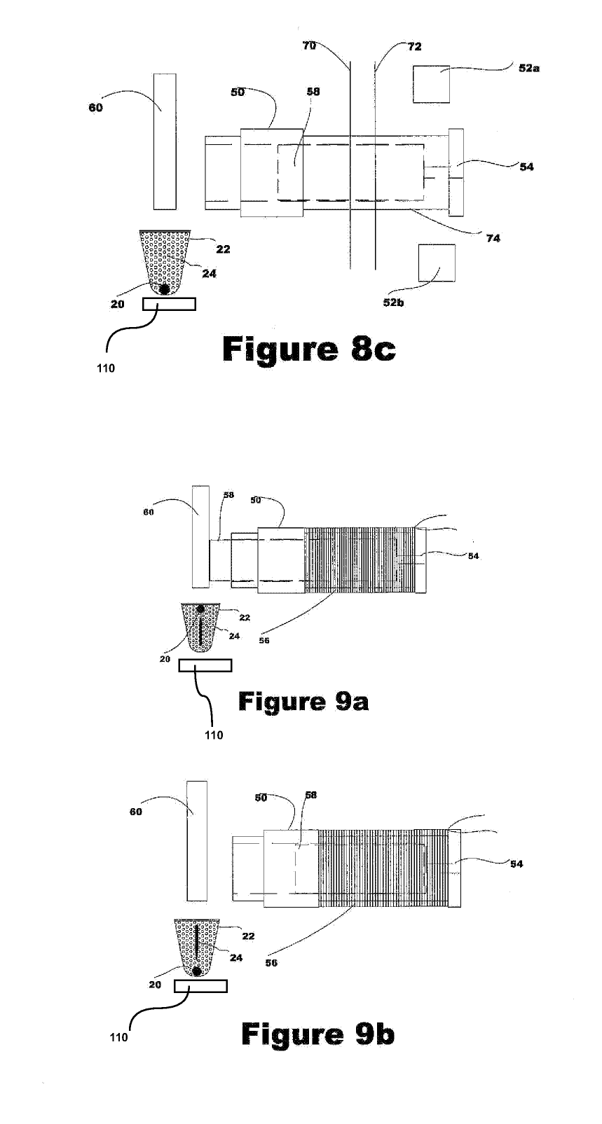

Another method of moving the magnet into position to move the bead in a reaction well or mixing chamber is disclosed in FIGS. 10a, 10b, and 10c. This method employs a rotating solenoid that is controlled with either a single on/off DC current or a Pulse Width Modulated DC current to control the speed of rotation. Again either a circuit or a microcontroller can be used to control the frequency of the rotation and, in the case of the PWM controlled solenoid, the speed of the rotation. Referring to FIG. 10a, a magnet 80 is attached to an arm 81 that is attached to the armature 82 of a rotating solenoid 83. The magnet used is again a rare earth magnet with sufficient magnetic flux to pull the bead 20 toward it when the magnet is brought into proximity of the well 22 and bead 20. FIG. 10b shows a top view of the rotating solenoid 83 that has been activated by a DC current. When activated, the magnet, attached to the solenoid 83 via the arm 81 and armature 82, is swung over the top of the well 22 in position to move the bead 20 through the solution 24 toward the magnet 80.

FIG. 10c shows the top view of the rotating solenoid 83 that has been de-activated. When de-activated, the magnet, attached to the solenoid 83 via the arm 81 and armature 82, is swung away from the well 22 into a position that allows the bead 20 to drop through the solution 24 toward the bottom of the well 22. Once again, if more rapid mixing were required, the same mechanism described here, or some other method of putting a magnetic flux at the bottom of the well could be used as disclosed in FIGS. 5a, 5b, 7a, and 7b.

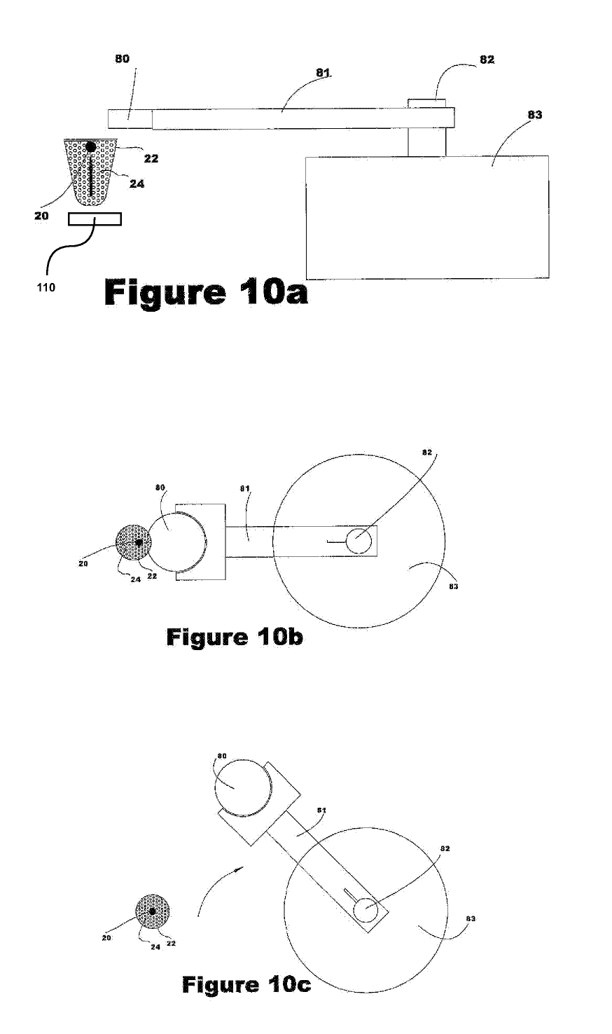

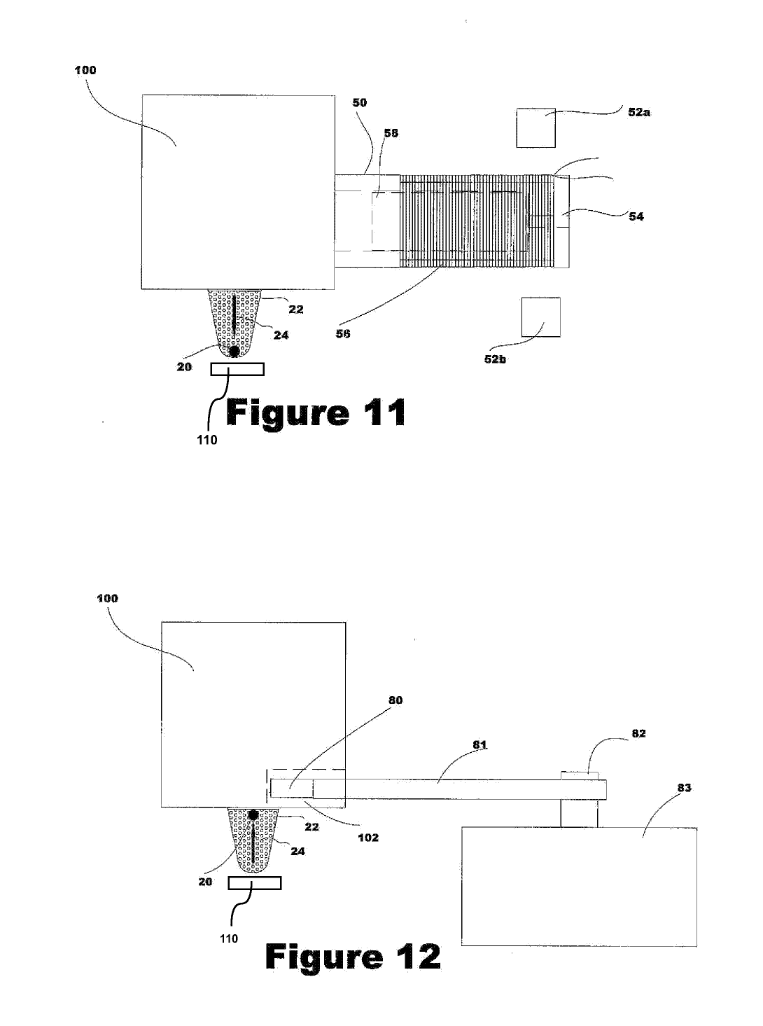

The methods described here can be used in association with optics systems. As one non-limiting example, FIG. 11 shows the method disclosed in FIGS. 8a, 8b, 8c, 50, 52a, 52b, 54 & 56 attached directly to an optics head 100 that is in position over the reaction well 22 so that readings of florescence levels can be taken during the reaction. The housing used to mount the magnets 52a and 52b is also used to secure the attachment of the bobbin 50 to the optics head 100. The specific housing arrangement is omitted for the sake of clarity. FIG. 12 shows an example of a possible arrangement to accommodate working with an optics head 100 where a rotating solenoid 83 is used to move the magnet 80 in and out of the position to move the bead 20 as disclosed in FIGS. 10a, 10b, and 10c. By removing some material 102 from the head 100, the magnet 80 can be swept under the optics systems head 100. Again, the optics head 100 is in position over the reaction well 22 so that readings of florescence levels can be taken during the reaction.

In another example, the optics can be moved away from the reaction well while mixing is occurring and then moved back into position to read florescence levels after mixing is done. In yet another example, the well can be moved away from the optics, the solution can be mixed, and the well can be brought back to the optics position to be read.

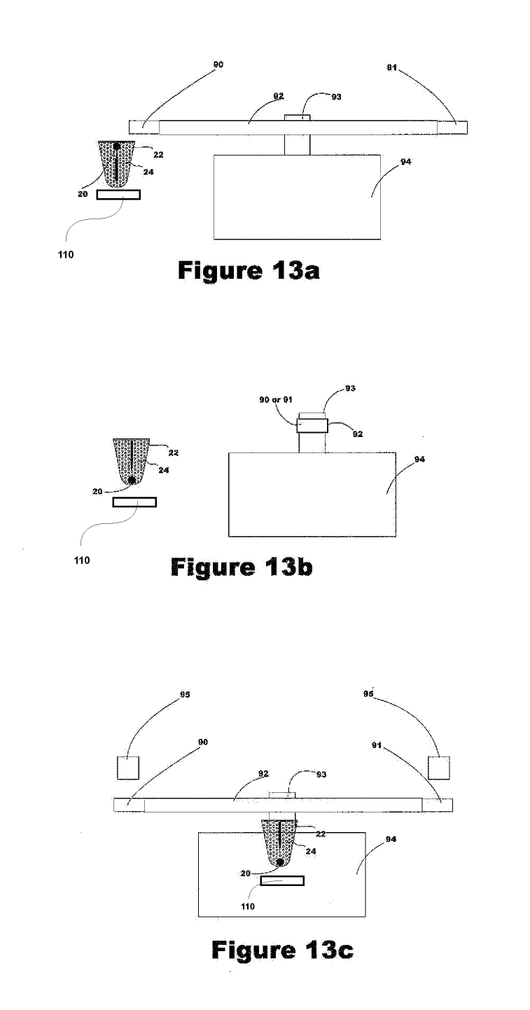

Another method to move the magnet into position to move the bead in a reaction well or mixing chamber is disclosed in FIGS. 13a, 13b and 13c. In this method, an armature 92 is attached to the shaft 93 of an electric motor 94.

Depending on the speed of the motor and the desired mixing frequency, a magnet 90, 91 can be attached at each end of the armature, or as another example, a magnet could be attached at one end 90 and a counterweight 91 attached at the other end of the armature. As the magnet passes over the well (as depicted in FIG. 13a), the bead will be pulled up, and as the magnet is positioned away from the well, the bead will be dropped (FIG. 13b). The position of the armature 92, thus the magnet or magnets 90, 91, when the motor is off can be determined by a position control switch or by placing magnets 95 of sufficient strength and of the opposite polarity of the magnet or magnets 90, 91 on the armature 92 at such a position as to draw the magnets away from the well 22, as shown in FIG. 13c. The armature 92 can be of any shape, including a disk, and can hold a single or a plurality of magnets and counter weights.

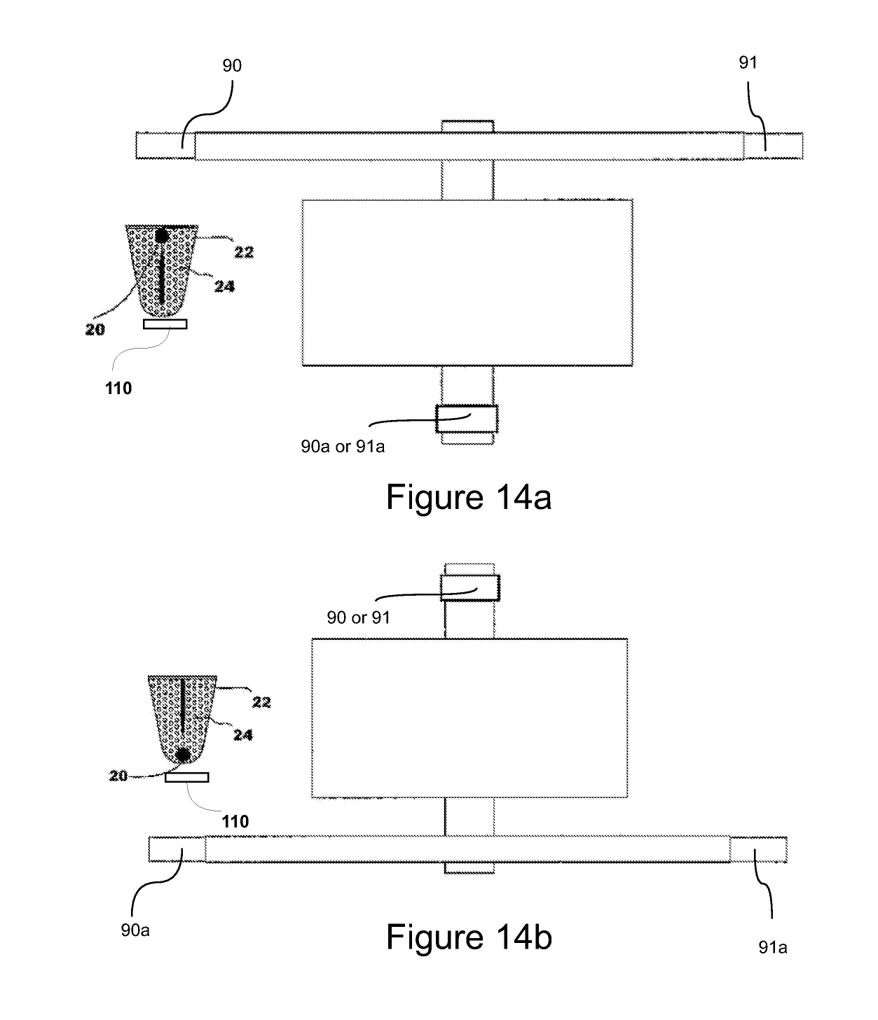

Additionally, FIGS. 14a-14b depict how a secondary armature may be attached to the apparatus of FIGS. 13a-13c wherein the second armature may be positioned below the closed cartridge reaction well and wherein the armature is located at a position being out-of-phase with the first armature. The second armature has additional magnets and counterweights 90a and 91a being embedded therein to provide a secondary magnetic field to the closed cartridge reaction well. The rotation of the shaft then passes the two armatures into their relative positions either above or below the reaction well and draws the bead up and down in a reciprocating fashion in order to achieve the desired mixing.

It is to be understood that the bead can be moved by the magnets in a variety of paths. A simple up-and-down motion can be achieved, or a simple side-to-side motion. In addition, helical patterns can be achieved, circular patterns, etc. The present technology provides a great deal of flexibility of movement of the magnetic bead.

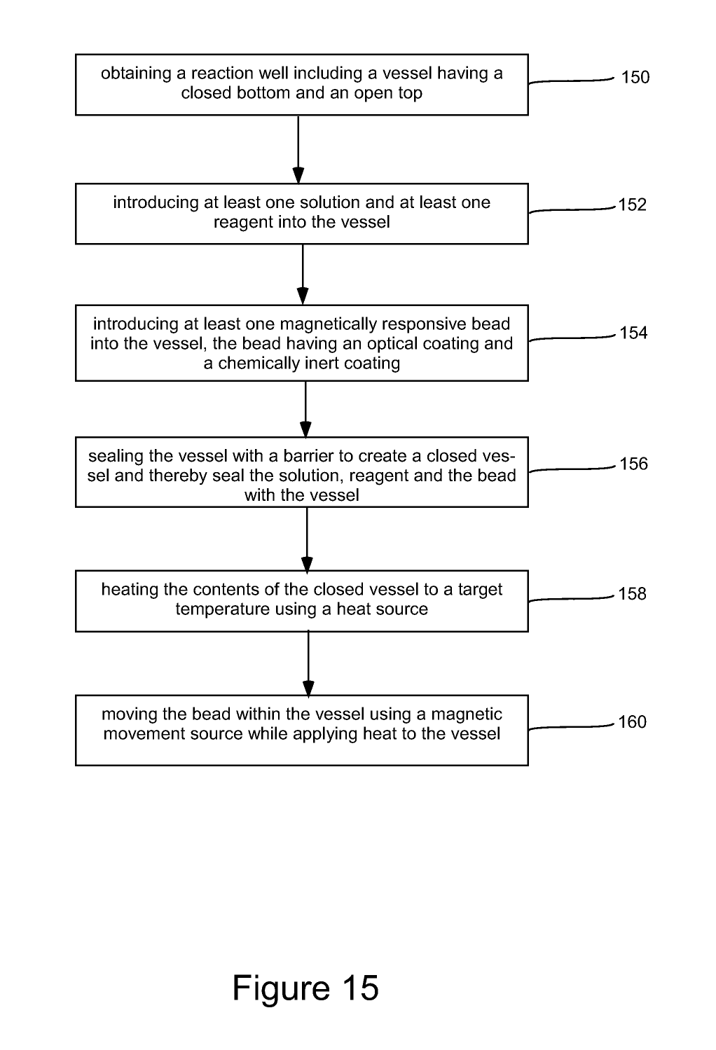

FIG. 15 illustrates one method of providing a homogeneous mixture of solutions and reagents during a heated reaction having a first step 150 including providing a reaction well having a vessel with a closed bottom and an open top. A second step 152 includes providing at least one solution and at least one reagent within the hollow vessel. A third step 154 includes providing at least one magnetically responsive bead having an optical coating and a chemically inert coating into the reaction well. A fourth step 156 includes sealing the reaction well with a barrier that circumvents and seals the open top to form a closed cartridge reaction well containing the solution, reagent and the bead. A fifth step 158 includes heating the contents of the closed cartridge reaction well to a target temperature using a heat source. A sixth step 160 includes moving the bead into an upper portion of the closed cartridge reaction well by oscillating a first magnetic field of a first magnet proximate a first external portion of the closed cartridge reaction well. A seventh step 162 includes moving the bead into a lower portion of the closed cartridge reaction well by oscillating a second magnetic field of a second magnet proximate a second opposing external portion of the closed cartridge reaction well. The method can include the further step of oscillating the first and second magnetic fields out of phase to cause the bead to move in a reciprocating fashion within the closed cartridge reaction well at a sufficient rate that the bead mixes the solution and reagent to have a homogeneous temperature and mixture.

It should be appreciated that additional steps, as would be recognized by one of ordinary skill in the art, may be employed to utilize each of the specific apparatus embodiments as discussed above.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A mixing system, comprising:
a reaction well including a vessel having an upper opening, a barrier, and a bottom, wherein the vessel is configured to contain at least one reagent and at least one solution, the barrier being configured to seal the upper opening to create a closed vessel;
a magnetically responsive bead having an optical coating thereon, the optical coating being configured to reduce any optical interference with optic measurement systems, and a clear parylene coating encapsulating the bead and the optical coating;
a heat source positioned near the reaction well and being operable to heat solution and reagents contained within the closed vessel;
a first magnet positioned near a first side of the reaction well and being configured to provide a first magnetic field through the reaction well, the first magnetic field being of sufficient strength so as to be capable of moving the magnetically responsive bead within the reaction well;
a system for oscillating the strength of the first magnetic field to alter a position of the magnetically responsive bead within the reaction well;
a second magnet positioned near a second side of the reaction well and configured to provide a second magnetic field through the reaction well, the second magnetic field being of sufficient strength so as to be capable of moving the magnetically responsive bead within the reaction well;
a system for oscillating the strength of the second magnetic field to alter a position of the magnetically responsive bead within the reaction well; and
wherein the oscillating systems for the first magnetic field and the second magnetic field operate out of phase with one another such that the magnetically responsive bead oscillates between an upper position within the closed vessel and a bottom position within the closed vessel such that the solution and reagents are mixed while being heated.

2. A system in accordance with claim 1, wherein the first and second magnets include electromagnet coils, and wherein the oscillating systems are capable of energizing and de-energizing the electromagnetic coils.

3. A system in accordance with claim 1, wherein the first and second magnets are permanent magnets, and wherein the oscillating systems include structure for physically moving the magnets into and out of proximity of the closed vessel.

4. A system in accordance with claim 2, wherein at least one of the magnets comprises an electromagnet having a displaceable core.

5. A system in accordance with claim 4, further comprising:
at least one return magnet operable to pull the displaceable core away from the stopper when the electromagnetic coils are de-energized.

6. A system in accordance with claim 3, further comprising:
a rotating shaft; and
a first armature extending radially outward from the rotating shaft, the first magnet being embedded in a distal end of the first armature; wherein
rotating the shaft causes the at least one permanent magnet to be passed into and away from close proximity to the closed cartridge reaction chamber.

7. A system in accordance with claim 6, further comprising:
a second armature extending radially outward from the rotating shaft in a direction non-parallel from the first armature, the second magnet being embedded in a distal end of the second armature;
wherein the first armature is configured to pass the first magnet into a position being proximate an upper portion of the closed vessel and displace the bead into the barrier; and
wherein the second armature is configured to pass the second magnet into a position being proximate the bottom of the closed vessel and return the bead into the bottom of the closed cartridge reaction well.

8. A mixing system, comprising:
a reaction well including a vessel having an upper opening, a barrier, and a bottom, wherein the vessel is configured to contain at least one reagent and at least one solution, the barrier being configured to seal the upper opening to create a closed vessel;
a magnetically responsive bead having an optical coating thereon, the optical coating being configured to reduce optical interference with optic measurement systems, and a secondary chemically inert coating encapsulating the bead and the optical coating;
at least a first magnet positioned near a first side of the reaction well and being configured to provide a first magnetic field through the reaction well, the first magnetic field being of sufficient strength so as to be capable of moving the magnetically responsive bead within the reaction well; and
a system for oscillating the strength of the first magnetic field to alter a position of the magnetically responsive bead within the reaction well.

9. A system in accordance with claim 8, further comprising a heat source positioned near the reaction vessel, the heat source enabling heating of the solution and reagents will the solution and reagents are mixed.

10. A system in accordance with claim 8, wherein the optical coating is white in color.

11. A system in accordance with claim 8, wherein the optical coating is a polished reflective material.

12. A system in accordance with claim 8, wherein the chemically inert coating is parylene.

13. A system in accordance with claim 8, further comprising:
a second magnet positioned near a second side of the reaction well and configured to provide a second magnetic field through the reaction well, the second magnetic field being of sufficient strength so as to be capable of moving the magnetically responsive bead within the reaction well; and
a system for oscillating the strength of the second magnetic field to alter a position of the magnetically responsive bead within the reaction well; and

14. A system in accordance with claim 13, wherein the first and second magnets include electromagnet coils, and wherein the oscillating systems are capable of energizing and de-energizing the electromagnetic coils.

15. A system in accordance with claim 13, wherein the first and second magnets are permanent magnets, and wherein the oscillating systems include structure for physically moving the magnets into and out of proximity of the closed vessel.

16. A system in accordance with claim 15, wherein at least one of the magnets comprises an electromagnet having a displaceable core.

17. A system in accordance with claim 16, further comprising:
at least one return magnet operable to pull the displaceable core away from the stopper when the electromagnetic coils are de-energized.

18. A method for providing a homogeneous mixture of solutions and reagents during a heated reaction process comprising:
obtaining a reaction well including a vessel having a closed bottom and an open top;
introducing at least one solution and at least one reagent into the vessel;
introducing at least one magnetically responsive bead into the vessel, the bead having an optical coating and a chemically inert coating;
sealing the vessel with a barrier to create a closed vessel and thereby seal the solution, reagent and the bead with the vessel;
heating the contents of the closed vessel to a target temperature using a heat source;
moving the bead within the vessel using a magnetic movement source while applying heat to the vessel.
